(19) United States
(12) Patent Application Publication
(10) Pub. No.: US 2006/0104353 A1
(43) Pub. Date: May 18, 2006

(54) Video signal preprocessing to minimize prediction error

(76) Inventors: Andrew W. Johnson, Cupertino, CA (US); Natan Peterfreund, Kiryat Tivon (IL); Paul Eric Haskell, Saratoga, CA (US)

Correspondence Address: FISH & RICHARDSON P.C., PO BOX 1022, MINNEAPOLIS, MN, 55440-1022, US

(21) Appl. No.: 10/990,943

(22) Filed: Nov. 16, 2004

(51) Int. Cl. H04N 11/04; H04N 7/12; H04B 1/66; H04N 11/02

(52) U.S. Cl. 375/240.03; 375/240.12

(57) ABSTRACT

Systems and methods for preprocessing a video signal are disclosed. In one method, a video signal is preprocessed prior to encoding by a motion compensated prediction encoding system. The method includes modifying an input video signal to maximize the input video signal's conformance with a prediction model used by the motion compensated prediction encoding system.

### TECHNICAL FIELD

This invention relates to video signal processing.

### BACKGROUND

Encoding is a process that can be used to facilitate the transmission of data between sources. Digital video encoding can be used for the transmission of compressed television signals for broadcast applications. Conventional digital video encoding includes the compression of a source video using a compression algorithm. The MPEG 1, H.261, H.262, H.263 and H.264 video coding standards describe the syntax of the bitstream that is generated following application of the compression algorithm to the source video. Prior to compression, a preprocessor can be used to assist in the efficiency of the coding process. Conventional preprocessing techniques process the source video to remove attributes that are not conducive to efficient coding. Preprocessing typically takes the form of noise reduction and/or filtering to reduce source content in the high spatial frequencies.

Referring now to FIG. 1, a conventional video encoder 100 is shown. Video encoder 100 can be any of a number of conventional encoders including those that support the MPEG-1, H.261, H.262, H.263, and H.264 video coding standards. Video encoder 100 encodes an input video signal 102 using a motion compensated prediction coding technique to produce an encoded output signal or encoded stream 104. As shown, video encoder 100 employs a hybrid motion-compensated differential pulse code modulation (MC-DPCM) architecture that is used by the MPEG-1, H.261, H.262, H.263, and H.264 video coding standards.

Video encoder 100 includes an encoding path and a feedback path. The encoding path includes a mixer 109, a discrete cosine transform (DCT) block 110, quantization block 112 and a bit stream generation block 114. The feedback path includes an inverse quantization block 120, inverse DCT block 121, mixer 122, delay element 124, and motion prediction block 126.

Input video signal 102 is received at mixer 109 where an encoder motion prediction signal 130 is subtracted to produce an encoder residual signal 132. The encoder residual signal 132 reflects an amount of error when the motion predicted signal produced in the feedback loop is subtracted from the input video signal 102. The error reflects how well or poorly the motion prediction block 126 performed. The encoder residual signal 132 is provided as an input to the DCT transform block 110. DCT transform block 110 transforms the error signal in the form of the encoder residual signal 132 producing a transformed residual signal 134. The transformed residual signal 134 is quantized in quantization block 112 producing a quantized encoder residual signal 136. The quantized encoder residual signal 136 is provided as an input to bit stream generation block 114 which in turn produces an encoded stream 104. The bit stream generation block 114 operates to code the motion compensated prediction residual (i.e., error signal embodied in the encoder residual signal 132) to produce a bit stream that is complaint with a defined syntax (e.g., coding standard). The encoded stream 104 can be provided as an input to a transmission source that in turn can transmit the encoded stream to a downstream device where it may be decoded and the underlying source video input recovered.

The feedback path includes a motion prediction block that decides how best to create a version of the current frame of video data using pieces of the past frame of video data. More specifically, the quantized encoder signal 136 is also provided as an input to an inverse quantization block 120 in the feedback path. The output of the inverse quantization block 120 is an inverse quantized transformed encoder residual signal 138. The inverse quantization block 120 seeks to reverse the quantization process to recover the transformed error signal. This block introduces error (i.e. quantization noise) between the encoder input signal and the encoders' coded and reconstructed input signal. The inverse quantized transformed encoder residual signal 138 is provided as an input to the inverse DCT block 121 that in turn produces an inverse quantized encoder residual signal 140. The inverse DCT block 121 seeks to reverse the transform process invoked by DCT block 110 so as to recover the error signal. The recovered error signal (i.e., the inverse DCT of the encoder residual signal 140) is mixed with the output of the motion prediction block 126 (i.e., encoder motion prediction signal 130) producing the reconstructed input video signal 142. The reconstructed input video signal 142 is provided as an input to the delay element 124. The delay imparted by delay element 124 allows for the alignment of frames in the encoding path and feedback path (to facilitate the subtraction performed by mixer 109). The delayed reconstructed encoder signal 144 is provided as a past frame input to motion prediction block 126.

Motion prediction block 126 has two inputs: a past-frame input (i.e., delayed reconstructed encoder signal 144) and a current-frame input (i.e., input video signal 102). Motion prediction block 126 generates a version of the past-frame input that resembles as much as possible (i.e., predicts) the current-frame using a motion model that employs simple translations only. Conventionally, a current frame is divided into two-dimensional blocks of pixels, and for each block, motion prediction block 126 finds a block of pixels in the past frame that matches as well as possible. The prediction blocks from the past frame need not be aligned to a same grid as the blocks in the current frame. Conventional motion prediction engines can also interpolate data between pixels in the past frame when finding a match for a current frame block (i.e., sub-pixel motion compensation). The suitably translated version of the past-frame input is provided as an output (i.e., encoder motion prediction signal 130) of the motion prediction block 126.

The prediction generated from a previously encoded frame of video is subtracted from the input in a motion compensation operation (i.e., by mixer 109). Compression takes place because the information content of the residual signal (i.e., encoder residual signal 132) typically is small when the prediction does a good job of representing the input. The motion compensated prediction residual is transformed, quantized and then coded as discussed above to produce a bit stream.

The nonzero signal in the motion predicted residual (i.e., encoder residual signal 132) originates from three primary sources: motion mismatch, quantization noise and aliasing distortion.

The motion prediction (i.e., encoder motion prediction signal 130) is a piecewise approximation of the input. The motion prediction is generated assuming motion between frames is simple and translational. Motion mismatch is the difference between the assumed motion model and true motion between input and reference frames.

The motion prediction of encoder 100 includes quantization noise. More specifically, the motion prediction signal (i.e., encoder motion prediction signal 130) contains quantization noise due to the motion prediction being performed on imperfectly encoded past video frames.

Aliasing distortion arises from the conventional interpolation filters (not shown) used in the motion prediction block 126 to generate sub-pixel precision motion predictions. The interpolation filters introduce aliasing distortion in the prediction when the prediction is extracted using sub-pixel motion vectors. The magnitude of this distortion component is dependent upon the spatial frequency content of the signal being interpolated and the stop band attenuation characteristics of the filter used to perform the interpolation.

To assist in the coding process, a preprocessor may be used. Referring to FIG. 2, a conventional coding system is shown including a preprocessor 200 and encoder 100.

Preprocessor 200 includes a processing path and a preprocessor feedback path. Mixer 210, filter 212 and mixer 214 are included in the processing path. Delay element 216 and motion prediction module 218 are included in the preprocessor feedback path.

Preprocessor 200 operates upstream from encoder 100 providing filtered video pictures to encoder 100. Motion prediction module 218 generates a version of a past filtered frame that matches the current input as closely as possible. The mixer 210 generates a prediction error to filter 212. Preprocessor 200 performs a spateo-temporal filtering operation on the input video signal. More specifically, preprocessor input video signal 220 is received at mixer 210 where a preprocessor prediction signal 222 is subtracted from the preprocessor input video signal 220 producing a preprocessor residual signal 224. The preprocessor residual signal 224 reflects the amount of filtering that can be performed in the processing path. The error reflects how well or poorly the motion prediction module 218 performed. The preprocessor residual signal 224 is provided as an input to filter 212. Filter 212 may implement any of a number of conventional filtering operations including linear and non-linear sample modifications. Filter 212 produces as an output a filtered preprocessor residual signal 226 that is provided as an input to a summation block (i.e., mixer 214) where it is combined with the preprocessor prediction signal 222. The combination of mixers 210, 214 and filter 212 produce a filtered input signal. The filtered signal (i.e., preprocessor output signal 228) is provided as an input to encoder 100.

The preprocessor 200 is a spateo-temporal filter. The preprocessor feedback path is used to generate a motion prediction signal. More specifically, the preprocessor output signal 228 is also provided as an input to delay element 216. The delay imparted by delay element 216 allows for the alignment of frames in the processing and preprocessor feedback paths (i.e., to facilitate the subtraction performed by mixer 210). The delayed preprocessor output (i.e., filtered) signal is provided as a past frame input to motion prediction module 218.

Motion prediction module 218 has two inputs: a past-processed frame input (i.e., delayed preprocessor output signal 230) and a current-frame input (i.e., preprocessor input video signal 220). Motion prediction module 218 generates a version of the past-frame input that resembles as much as possible (i.e. predicts) the current-frame input. The suitably translated version of the past-frame input is provided as an output (i.e., preprocessor prediction signal 222) of the preprocessor motion prediction block 218.

The prediction generated from a previously encoded frame of video is subtracted from the input in a motion compensation operation (i.e., by mixer 210). Preprocessor 200 may simply output the motion predicted signal directly (if filter 212 always outputs zero). In this case, however, the visual appearance of the preprocessor output signal 228 might not be pleasing. For example, block edge discontinuities may become visible as a result of different translations imposed on adjacent blocks. To help improve the appearance of the preprocessed video, filter 212 may perform linear and nonlinear sample modifications on the difference between the original input video and the motion predicted input video. The filtering operations may adapt based on the difference between the two input signals, or on the presence of structures such as block edge discontinuities. Also, the filtering operations additionally can adapt based on the state of the Encoder (e.g. quantizer step size, error between encoder input and motion predicted reconstruction).

### SUMMARY

In one aspect, a method is provided for preprocessing a video signal prior to encoding by an encoder system. The method includes receiving a signal including quantization noise introduced in an encoder system that processed a prior frame of an input video signal and introducing a component of the quantization noise into a signal that is provided as an input to the encoder system.

Aspects of the invention can include one or more of the following features. The step of receiving a signal includes receiving an encoder motion prediction signal that includes quantization noise. The step of introducing a component of the quantization noise includes combing the encoder motion prediction signal and a current frame of the input video signal. The step of combining can result in the substraction of the encoder motion prediction signal from a current frame of the input video signal producing a preprocessor residual signal which can be filtered to produce a filtered preprocessor residual signal. The step of filtering can include the application of a filter operation to the preprocessor residual signal where the input video signal can be multiplied (by a fraction between 0 and 1).

The step of filtering can include providing a plurality of filter operations, selecting one of the filter operations from the plurality of filter operations based on a predetermined criteria which can include a level of perturbation in the input video signal, and applying the selected filter operation to the preprocessor residual signal. The first filter operation can input video signals having perturbations in the input video signal less than a first predetermined level, and applying a second different filter operation to input video signals having perturbations more than the first predetermined level. The step of combining the encoder motion prediction signal and the filtered preprocessor signal can include adding the encoder motion prediction signal and the filtered preprocessor signal. The step of combining can directly modify the input video signal including modifying the input video signal based on a motion prediction of the input video signal. The step of directly modifying can include modifying the input video signal to provide a motion compensated prediction of an encoder prediction signal and providing the motion compensated prediction as an input to the encoder system.

The step of combining can include preprocessing the video input signal to produce a preprocessed video input signal. The combination of the pre-processed video input signal with the encoder motion prediction signal can include weighting a combination of the preprocessed video input signal and the encoder motion prediction signal. The combination of the encoder motion prediction signal with the motion prediction estimate of the preprocessor can include combining by using a weighting function which can include disregarding the encoder motion prediction signal and the motion prediction estimate of the preprocessor. The step of weighting the combination can include generating a weighted combination of both the encoder motion prediction signal and the motion prediction estimate.

In another aspect, an apparatus is provided for preprocessing a video signal prior to encoding by an encoder system. The apparatus includes a preprocessor operable to receive an input video signal and an encoder signal and produce as an output a preprocessor output signal. The encoder signal can include quantization noise introduced in an encoder system that processed a prior frame of the input video signal. The preprocessor can be operable to introduce quantization noise from the encoder signal into the preprocessor output signal.

Aspects of the invention can include one or more of the following features. The preprocessor can be operable to receive an encoder motion prediction signal that includes quantization noise and can combine the encoder motion prediction signal and a current frame of the input video signal. The preprocessor can include a mixer operable to substract the encoder motion prediction signal from a current frame of the input video signal producing a preprocessor residual signal. The preprocessor can include a filter operable to filter the preprocessor residual signal producing a filtered preprocessor residual signal.

The filter can include a filter operation. The filter can be operable to apply the filter operation to the preprocessor residual signal so that the video input signal is multiplied (by a fraction between 0 and 1). The filter can include a plurality of filters and a selector for selecting and applying one of the plurality of filters based on a predetermined criteria which can include a level of perturbation of the input video signal. The selector can be operated to apply a first filter to input video signals having perturbations in the input video signal less than a first predetermined level and apply a second different filter to input video signals having perturbations more than the first predetermined level.

A mixer can be included to combine the encoder motion prediction signal and filtered preprocessor residual signal. The mixer can add the encoder motion prediction signal and the filtered preprocessor.

The preprocessor can be operable to directly modify the input video signal including modifying the input video signal based on a motion prediction of the input video signal. The preprocessor can include a motion compensation module operable to directly modify the input video signal to provide a motion compensated prediction of an encoder prediction signal and provide the motion compensated prediction as an input to the encoder system.

The preprocessor can include a motion compensation module operable to directly modifying the input video signal to provide a motion compensated prediction of an encoder prediction signal and provide the motion compensated prediction as an input to the encoder system. The processor can be operable to preprocess the video input signal to produce a preprocessed video input signal and to combine the preprocessed video input signal with the encoder motion prediction signal. The preprocessor can include a second preprocessor that can be operated to combine the preprocessed video input signal with the encoder motion prediction signal. The second preprocessor can include a mixer operable to combine the preprocessed video input signal with the encoder motion prediction signal. The mixer can be operated to provide a weighted combination of the preprocessed video input signal and the encoder motion prediction signal.

The preprocessor can be operated to combine a motion prediction estimate produced by the preprocessor of the input video signal and the encoder motion prediction signal. The preprocessor can include a motion prediction module that is operable to produce a motion compensated estimate of the video input signal and a sigma module that can be operated to combine the motion compensated estimate produced by the motion compensation module and the encoder motion prediction signal. The sigma module can be operated to weight a combination of the motion compensated estimate and the encoder motion prediction signal. The sigma module can be configured to disregard the encoder motion prediction signal in the combination and to disregard the motion compensated estimate in the combination. The sigma module can be configured to generate a weighted combination of both the encoder motion prediction signal and the motion compensated estimate.

In another aspect, a method is provided for preprocessing a video signal prior to encoding by a motion compensated prediction encoding system. The method includes modifying an input video signal to maximize the input video signal's conformance with a prediction model used by the motion compensated prediction encoding system.

In another aspect, a method is provided for preprocessing a video signal prior to encoding in an encoding system. The method includes blending a current input video frame with an encoder system's motion-predicted reconstruction producing a blended frame with quantization noise and providing the blended frame to the encoder system for encoding.

The details of one or more embodiments of the invention are set forth in the accompanying drawings and the description below. Other features, objects, and advantages of the invention will be apparent from the description and drawings, and from the claims. Aspects of the invention can realize one or more of the following advantages. In one implementation, a video preprocessing system and method is provided that minimizes the energy in a motion compensated residual produced by a motion compensated prediction video encoding system. A preprocessor is provided that modifies the input source to minimize the prediction error (“residual”) signal in the motion compensated prediction video encoding system.

In one implementation, a video preprocessing system is provided that is configured to add noise into the input of its respective encoder. By adding noise to the encoder input signal, the encoder can advantageously save encoding bits allowing for more encoding bits to be used on the actual video data. More specifically, a conventional encoder's quantization block introduces error (“quantization noise”) between the encoder's estimate of the current input picture and its actual input. For every succeeding picture, the encoder not only must code its new input, but it must encode the quantization noise introduced when coding its previous input. A video processing system is provided that reduces the number of bits the encoder spends encoding noise. In one implementation, the video processing system reduces the number of bits the encoder spends encoding noise by adding a predetermined amount of quantization noise into the encoder's input. The proposed system allows the encoder to quantize more finely-introducing less quantization error overall. In one implementation, a video encoder system is provided that includes a controllable amount of the encoder quantization error that can be reintroduced into the encoder at the encoder's input.

A conventional encoder's approximation of the current input video frame as discussed above is not only imperfect because of quantization noise, but also suffers imperfections because the way that the motion prediction block estimates the true motion in the video sequence is, itself, imperfect. A video coding system must typically define the details of its motion prediction, so a corresponding decoding system can

perform exactly the same prediction operations given the proper motion data (and recover the underlying source data). For example, MPEG-2 performs motion compensation on 16×16 blocks of pixels at a precision of ½ pixel. In one implementation, the encoder employs only a simple translational motion model to describe motion between frames of a video sequence. The encoder can provide finer motion compenstation precision than that specified by the underlying standard describing the bitstream syntax. If a video sequence contains motion that is very well described by the translational motion of blocks of pixels whose motions are multiples of ½ pixel, then MPEG-2 compression process will represent the video sequence very efficiently. However, real-world video is not always so well behaved. In one implementation, a preprocessor is provided that manipulates its input video so that it is well behaved according to the constraints of the following encoder. The preprocessor can be configured to allow for input modifications to source video that are not restricted to simple translations and noise inclusion. Non translational motion such as zooms and rotations can be incorporated in the preprocessing of the source video.

### DESCRIPTION OF DRAWINGS

FIG. 1 is a conventional video encoder.

FIG. 2 is a conventional coding system, including a preprocessor and encoder.

FIG. 3 is a coding structure, including an encoder and preprocessor.

FIG. 4 is a preprocessor coupled to an encoder.

FIG. 5 is a combination of a conventional preprocessor, an encoder and a second preprocessor.

FIG. 6 is an alternative motion compensated prediction encoding system that includes a preprocessor and an encoder.

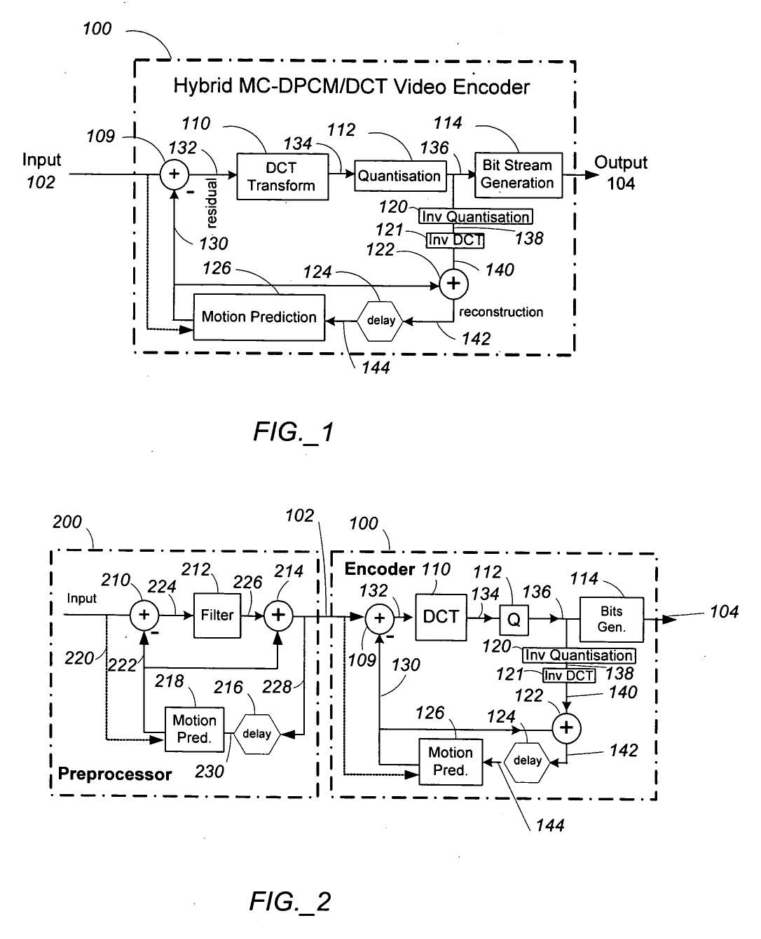

Like reference symbols in the various drawings indicate like elements.

### DETAILED DESCRIPTION

Systems and methods are described for implementing video processing techniques that minimize the energy in the motion compensated residual of a motion compensated prediction video encoding architecture.

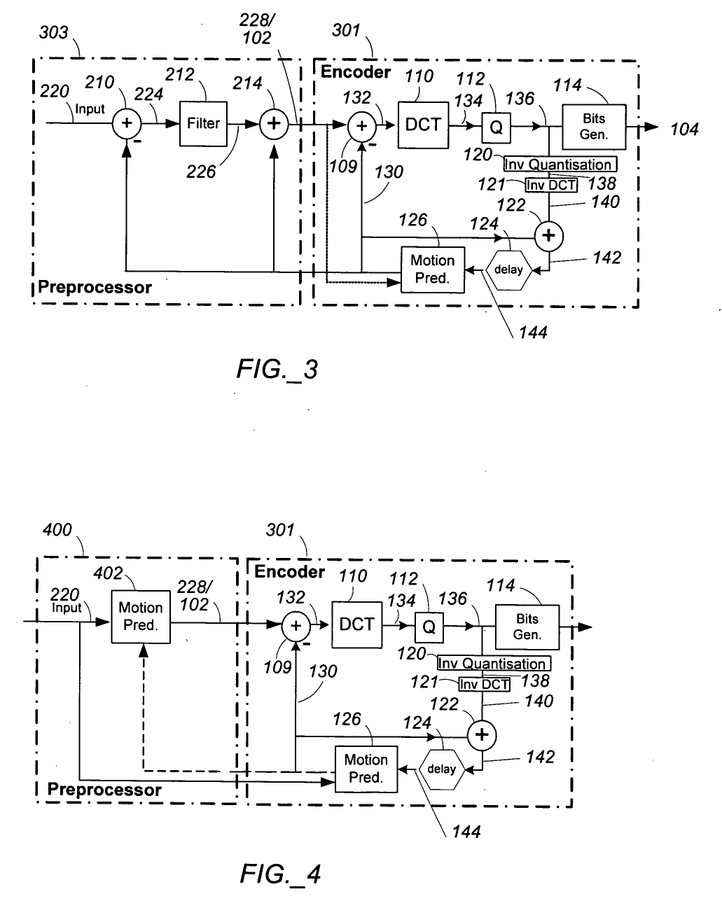

Referring now to FIG. 3, coding structure 300 including an encoder 301 and preprocessor 303 is shown. Preprocessor 303 operates upstream from encoder 301 providing filtered video pictures to encoder 301.

Preprocessor 303 includes processing path and preprocessor feedback path. Mixer 210, filter 212 and mixer 214 are included in the processing path. A motion prediction module 126 in encoder 301 generates an encoder motion prediction signal 130 that is provided as an input to preprocessor 303, forming part of the preprocessor feedback path. Encoder motion prediction signal 130 is discussed in greater detail below with reference to encoder 301.

Preprocessor input video signal 220 is received at mixer 210 where an encoder motion prediction signal 130 is subtracted from the preprocessor input video signal 220 producing a preprocessor residual signal 224. The preprocessor residual signal 224 reflects the error between the encoders prediction (i.e., the encoder motion prediction signal 130) generated by the motion prediction block 126 and the preprocessor input video signal 220. The error reflects how well or poorly the motion prediction module 126 performed. Accordingly, motion prediction block 126 forms part of the preprocessor feedback path. The operation of motion prediction block 126 is discussed in greater detail below.

The preprocessor residual signal 224 is provided as an input to filter 212. Filter 212 may implement any of a number of conventional linear and non-linear filtering operations. Filter 212 produces as an output a filtered preprocessor residual signal 226 that is provided as an input to a summation block (i.e., mixer 214) where it is again combined with the encoder motion prediction signal 130 generated by the motion prediction module 126 of encoder 301. The combination of mixers 210, 214 and filter 212 produce a filtered input signal. The filtered signal (i.e., preprocessor output signal 228) is provided as an input to encoder 301. In one implementation, preprocessor 303 may simply output the filtered preprocessor signal (i.e., the output of filter 212) to DCT block 110 of encoder 301 directly (i.e., the reflexive operation of the addition and the subtraction of the encoder motion prediction signal 130 can be eliminated). To help improve the appearance of the preprocessed video, filter 212 may perform linear and nonlinear operations on the samples making up the filtered preprocessor residual signal 226. The filtering operations may adapt based on the difference between the two input signals to mixer 210, on the presence of processing artifacts such as block edge discontinuities, etc., or on the state of the encoder 301 (e.g. quantizer step size, or error between encoder input and motion predicted reconstruction).

Video encoder 301 can be any of a number of conventional encoders including those that support the MPEG-1, H.261, H.262, H.263, and H.264 video coding standards. Video encoder 301 encodes an input video signal 102 using a motion compensated prediction coding technique to produce an encoded output signal or encoded stream 104. As shown, video encoder 301 is of the form of a hybrid motion-compensated differential pulse code modulation (MC-DPCM) encoder used by the MPEG-1, H.261, H.262, H.263, and H.264 video coding standards.

Video encoder 301 includes an encoding path and an encoder feedback path. Encoding path includes a mixer 109, a discrete cosine transform (DCT) block 110, quantization block 112 and a bit stream generation block 114. As noted above, mixer 109 may not be required in an implementation that includes no mixer 214 in the preprocessor 303 structure. The encoder feedback path includes an inverse quantization block 120, inverse DCT block 121, mixer 122, delay element 124, and motion prediction block 126.

Input video signal 102 (i.e., preprocessor output signal 228) is received at mixer 109 where an encoder motion prediction signal 130 is subtracted from the input video signal 102 producing an encoder residual signal 132. The encoder residual signal 132 reflects an amount of error when the motion predicted signal produced in the encoder feedback path is subtracted from the input video signal 102. The error reflects how well or poorly the motion prediction block 126 performed. The encoder residual signal 132 is provided as an input to the DCT transform block 110. DCT transform block 132 transforms the error signal in the form of the encoder residual signal 132 producing a transformed residual signal 134. The transformed residual signal 134 is quantized in quantization block 112 producing a quantized encoder signal 136. The encoder's quantization block 112 introduces error (i.e., quantization noise) between the encoder's estimate of the current input signal and the actual signal. The quantized encoder signal 136 is provided as an input to bit stream generation block 114 which in turn produces an encoded stream 104. The bit stream generation block 114 operates to code the motion compensated prediction residual (i.e., error signal embodied in the encoder residual signal 132) to produce a bit stream that is complaint with a defined syntax (e.g., coding standard). The encoded stream 104 can be provided as an input to a transmission source that in turn can transmit the encoded stream to a downstream device where it may be decoded and the underlying source video input recovered.

The encoder feedback path includes a motion prediction block that decides how best to create a version of the current frame of video data using pieces of the past frame of video data. More specifically, the quantized encoder signal 136 is also provided as an input to an inverse quantization block 120 in the encoder feedback path. The output of the inverse quantization block 120 is an inverse quantized transformed encoder residual signal 138. The inverse quantization block 120 seeks to reverse the quantization process to recover the transformed error signal. The inverse quantized transformed encoder residual signal 138 is provided as an input to the inverse DCT block 121 that in turn produces an inverse quantized encoder residual signal 140. The inverse DCT block 121 seeks to reverse the transform process invoked by DCT block 110 so as to recover the error signal. The recovered error signal (i.e., the inverse DCT of the inverse quantized encoder residual signal 140) is mixed with the output of the motion prediction block 126 (i.e., encoder motion prediction signal 130) producing the reconstructed input signal 142. The reconstructed input signal 142 is provided as an input to the delay element 124. The delay imparted by delay element 124 allows for the alignment of the frames in the encoding and feedback paths (to facilitate the subtraction performed by mixer 109). The delayed reconstructed encoder signal 144 is provided as a past frame input to motion prediction block 126.

Motion prediction block 126 has two inputs: a past-frame input (i.e., delayed reconstructed encoder signal 144) and a current-frame input (i.e., input video signal 102). Motion prediction block 126 generates a version of the past-frame input that resembles as much as possible (i.e. predicts) the current-frame using a motion model that, in one implementation, employs simple translations only. In one implementation, a current frame is divided into two-dimensional blocks of pixels, and for each block, motion prediction block 126 finds a block of pixels in the past frame that matches the current block as well as possible. The prediction blocks from the past frame need not be aligned to a same grid as the blocks in the current frame. In one implementation, motion prediction block 126 operates to interpolate data between pixels in the past frame when finding a match for a current frame block (i.e., sub-pixel motion compensation). The suitably translated version of the past-frame input is provided as an output (i.e., encoder motion prediction signal 130) of the motion prediction block 126.

The prediction generated from a previously encoded frame of video is subtracted from the input in a motion compensation operation (i.e., by mixer 109). Compression takes place because the information content of the residual signal (i.e., encoder residual signal 132) typically is small when the prediction does a good job of representing the input. The motion compensated prediction residual of the encoder(i.e., the error reflected in the output of mixer 109) is transformed, quantized and then coded as discussed above to produce a bit stream. The prediction from a previously encoded frame of video is also provided as an input to preprocessor 303. In the implementation shown, the encoder motion prediction signal 130 is provided as an input to mixers 210 and 214 in preprocessor 303.

Preprocessor 303 operation is designed explicitly to minimize the energy of the residual signal in the motion compensated prediction encoding architecture. Preprocessor's 303 objective is to modify the input signal (i.e., the preprocessor input signal 220) to maximize its conformance with the prediction model used by the encoder 301, to reduce temporal redundancy without adversely affecting the reconstructed signal subjective quality. In the implementation shown in FIG. 3, the preprocessing operation takes the form of modifying the difference between sample values of the current input video frame (i.e., the preprocessor input signal 220) and the sample values making up the encoder's motion-predicted reconstruction (i.e., encoder motion prediction signal 130).

In the background discussion, conventional preprocessors operate on current and previous input video frames, which have not been compressed and thus which contain no quantization noise. Preprocessor 303 has been configured to combine the encoder's 301 reconstructed video with the input video signal. When the preprocessor 303 blends the reconstructed video (i.e., encoder motion prediction signal 130) with the input (i.e., preprocessor input signal 220), preprocessor 303 introduces quantization noise into the input signal provided to the encoder 301. The introduction of quantization noise to the input of encoder 301 serves to reduce the strength of the encoder's residual signal. When well controlled, the introduction of noise enables the use of a finer quantizer step size within the encoder 301, thus reducing the amount of quantization noise in the output (i.e., encoder output signal 104) of encoder 301.

Filter 212 in preprocessor 303 is configured to modify the difference between the reconstruction signal (i.e., the encoder motion prediction signal 130) and the unmodified input (i.e., the preprocessor input 220) so that the preprocessor output signal 228 tracks the unmodified input, encodes easily and minimizes quantization noise at the output of encoder 301. In one implementation, characteristics such as block edge discontinuities, and encoder 301 information are used to blend the encoder motion prediction signal 130 and the preprocessor input signal 220. One example of encoder 301 information includes quantizer step size of quantization block 112.

Any of a number of conventional filter operations can be supported by filter 212. In one implementation, filter 212 provides an output equal to a constant (K) multiplied by the input for some range of values for the constant (e.g., K * input (for some 0<K<1)). This simple filter operation provides noise reduction, but at the expense of image softening. In one implementation, filter 212 implements a more complex filter operation that reduces small input values (likely due to noise) more than large input values (likely due to large changes in the input video. One example of such a more complex filter operation provides one output value for small input values (if (ABSOLUTE_VALUE (input)<T) output=K * input) and a second value for large input value (else output=input).

In an alternative implementation shown in FIG. 4, a preprocessor 400 is coupled to encoder 301. Preprocessor 400 includes a motion prediction block 402. Motion prediction block 402 provides motion compensation of the preprocessor input signal 220 before encoding. Preprocessor 400 operates upstream from encoder 301 providing motion predicted video pictures to encoder 301.

Preprocessor 400 directly modifies the original input video (i.e., preprocessor input signal 220) to provide a better match to the encoder prediction signal 130 generated by block 126. In one implementation, the modifications performed by preprocessor 400 are spatial only. Direct modification as proposed minimizes the error between the encoder input (i.e., encoder input signal 102) and the encoder prediction signal (encoder motion predicted signal 130). Preprocessor 400 modifies the preprocessor input signal 220 directly so that the preprocessor input can be encoded more efficiently. In one implementation, the modification made by motion prediction block 402 is made sufficiently small so that the encoder 301 output tracks the preprocessor input signal reasonably closely. The inputs to motion prediction block 402 are the preprocessor input video signal 220 and the encoder motion prediction signal 130 generated by block 126. For example, when the motion prediction block 126 in the encoder 301 performs ¼ pixel precision motion estimation, the motion prediction block 402 in preprocessor 400 can be configured to perform ⅛ pixel precision motion estimation where the input signal 220 is modified to predict signal 130 generated by motion prediction block 126. The result of this ⅛ pixel block perturbation is to move the input so that it can be well represented by the encoder's ¼ pixel motion estimation without an appreciable residual signal. While motion estimation is performed by the encoder to ¼ pixel precision, motion compensation performed by mixer 109 now has ⅛ pixel precision. In one implementation, sample modifications provided by preprocessor 400 are not identical in each block or sub-block. In one implementation, the sample modifications are not restricted to block translations; modifications can compensate for non-translation motion, such as rotations, warping, or zooms as well.

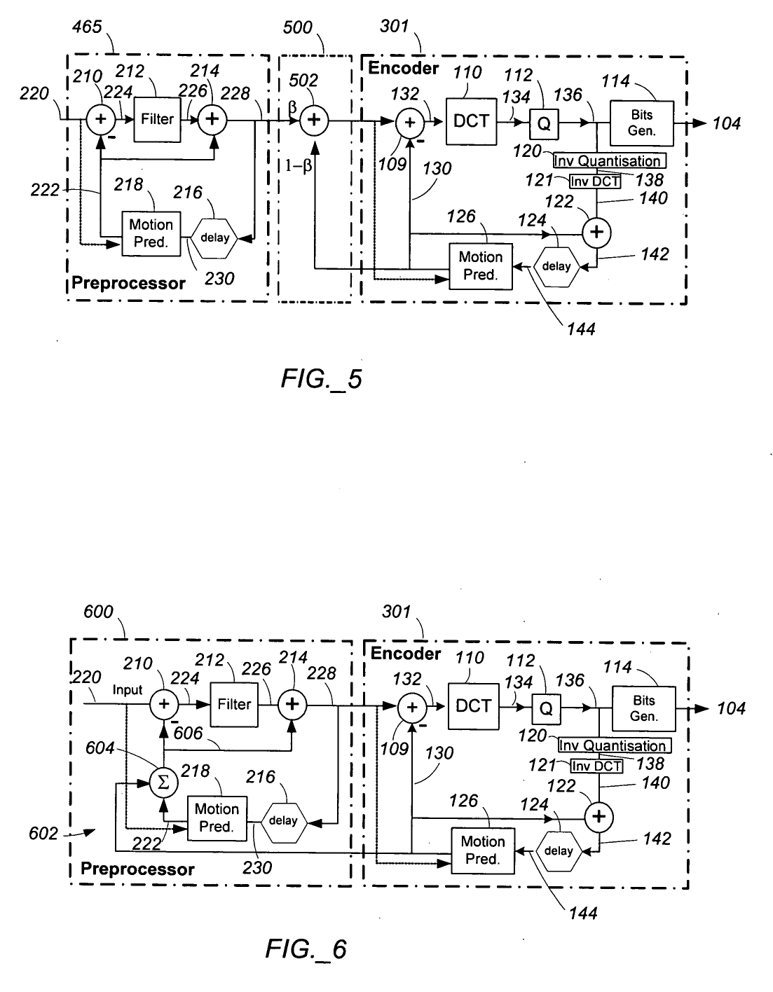

Combinations of traditional preprocessing and encoding techniques and the preprocessing and encoding methods disclosed herein are possible. Referring now to FIG. 5, a combination of a conventional preprocessor 200, an encoder 301 and a second preprocessor 500 is shown. Conventional preprocessor 200 provides an output, preprocessor output signal 228, as an input to second preprocessor 500. Second preprocessor 500 includes a mixer 502. One input to mixer 502 is preprocessor output signal 228. A second input to mixer 502 is the encoder motion predicted signal 130. Mixer 502 allows for introduction of quantization noise to the input of encoder 301, again allowing for a better encoding of the input signal. In one implementation, the respective inputs (i.e., the preprocessor output signal 228 and the encoder motion prediction signal 130) to mixer 502 are weighted to create a weighted mix. The weighting can be fixed or varied over time.

FIG. 6 shows an alternative motion compensated prediction encoding system that includes preprocessor 600 and encoder 301. Preprocessor 600 is similar to preprocessor 200 and includes a feedback path that includes sigma block 604. Sigma block 604 outputs a weighted preprocessor residual signal 606 that is a weighted sum of its two inputs, encoder motion prediction signal 130 and preprocessor residual signal 224. In one implementation, the weighting is adjusted over time and with characteristics of the inputs. In one implementation the weighting is fixed. For example, sigma block 604 can be configured to output only the preprocessor residual signal 224, thereby functioning similar to a conventional preprocessor as shown in FIG. 2. Alternatively, sigma block 604 can be configured to output only the encoder motion prediction signal 130, thereby functioning similar to preprocessor 303 as shown in FIG. 3. In an alternative implementation, sigma block 604 is configured to provide an output signal, weighted preprocessor residual signal 606, in accordance with a predefined formula (e.g., weighted preprocessor residual signal 606=K*(Preprocessor residual signal 224)+(1−K)*(encoder motion prediction signal 130)). Weighting, as discussed herein, allows for fine control over the quantization noise introduced to the input of encoder 301. More specifically, the choice of the constant K gives the system control over how much of the encoder quantization error is reintroduced into the encoder input. The choice of K also controls the frequency response of the system to the quantization noise; that is, how much the system retains “high-frequency” quantization noise versus how much the system retains “low-frequency” quantization noise. In one implementation, the constant K is set to a value of two (K=2). In this example, the system suppresses low-frequency quantization noise very effectively, but enhances high-frequency noise.

This invention has been described in terms of particular embodiments. Nevertheless, it will be understood that various modifications may be made without departing with the spirit and scope of the invention. Accordingly, other embodiments are within the scope of the following claims.

A number of embodiments of the invention have been described. Nevertheless, it will be understood that various modifications may be made without departing from the spirit and scope of the invention. Accordingly, other embodiments are within the scope of the following claims.

What is claimed is:

1. A method for preprocessing a video signal prior to encoding by an encoder system, the method comprising:
receiving a signal including quantization noise introduced in an encoder system that processed a prior frame of an input video signal; and
introducing a component of the quantization noise into a signal that is provided as an input to the encoder system.

2. The method of claim 1 wherein the step of receiving a signal includes receiving an encoder motion prediction signal that includes quantization noise; and wherein the step of introducing a component of the quantization noise includes combining the encoder motion prediction signal and a current frame of the input video signal.

3. The method of claim 2 wherein the step of combining further comprises subtracting the encoder motion prediction signal from a current frame of the input video signal producing a preprocessor residual signal.

4. The method of claim 3 further comprising filtering the preprocessor residual signal producing a filtered preprocessor residual signal.

5. The method of claim 4 wherein the step of filtering includes applying a filter operation to the preprocessor residual signal where the input video signal is multiplied by a fraction between 0 and 1.

6. The method of claim 4 wherein the step of filtering includes providing a plurality of filter operations, selecting one of the filter operations from the plurality of filter operations based on a predetermined criteria and applying the selected filter operation to the preprocessor residual signal

7. The method of claim 6 wherein the predetermined criteria includes a level of perturbation in the input video signal.

8. The method of claim 7 wherein the step of applying includes applying a first filter operation to input video signals having perturbations in the input video signal less than a first predetermined level, and applying a second different filter operation to input video signals having perturbations more than the first predetermined level.

9. The method of claim 4 further comprising combining the encoder motion prediction signal and filtered preprocessor residual signal.

10. The method of claim 7 wherein the step of combining the encoder motion prediction signal and the filtered preprocessor signal includes adding the encoder motion prediction signal and the filtered preprocessor signal.

11. The method of claim 2 wherein the step of combining further comprises directly modifying the input video signal including modifying the input video signal based on a motion prediction of the input video signal.

12. The method of claim 9 wherein the step of directly modifying includes modifying the input video signal to provide a motion compensated prediction of an encoder prediction signal and providing the motion compensated prediction as an input to the encoder system.

13. The method of claim 2 wherein the step of combining includes
preprocessing the video input signal to produce a preprocessed video input signal; and
combining the pre-processed video input signal with the encoder motion prediction signal.

14. The method of claim 11 wherein the step of combining the preprocessed video input signal and the encoder motion prediction signal includes weighting a combination of the preprocessed video input signal and the encoder motion prediction signal.

15. The method of claim 1 wherein the step of combining includes
combining a motion prediction estimate produced by a preprocessor of the input video signal and the encoder motion prediction signal.

16. The method of claim 13 wherein the step of combining the encoder motion prediction signal with the motion prediction estimate of the preprocessor includes combining using a weighting function.

17. The method of claim 14 wherein the step of weighting the combination includes disregarding the encoder motion prediction signal.

18. The method of claim 14 wherein the step of weighting the combination includes disregarding the motion prediction estimate of the preprocessor.

19. The method of claim 14 wherein the step of weighting the combination includes generating a weighted combination of both the encoder motion prediction signal and the motion prediction estimate.

20. An apparatus for preprocessing a video signal prior to encoding by an encoder system, the apparatus comprising:
a preprocessor operable to receive an input video signal and an encoder signal and produce as an output a preprocessor output signal, the encoder signal including quantization noise introduced in an encoder system that processed a prior frame of the input video signal, the preprocessor operable to introduce quantization noise from the encoder signal into the preprocessor output signal.

21. The apparatus of claim 20 wherein the preprocessor is operable to
receive an encoder motion prediction signal that includes quantization noise; and
combine the encoder motion prediction signal and a current frame of the input video signal.

22. The apparatus of claim 21 wherein the preprocessor further includes a mixer operable to subtract the encoder motion prediction signal from a current frame of the input video signal producing a preprocessor residual signal.

23. The apparatus of claim 22 wherein the preprocessor further comprises a filter operable to filter the preprocessor residual signal producing a filtered preprocessor residual signal.

24. The apparatus of claim 23 wherein the filter includes a filter operation and the filter is operable to apply the filter operation to the preprocessor residual signal so that the video input signal is multiplied by a fraction between 0 and 1.

25. The apparatus of claim 23 wherein the filter includes a plurality of filters and a selector for selecting and applying one of the plurality of filters based on a predetermined criteria

26. The apparatus of claim 25 wherein the predetermined criteria includes a level of perturbation of the input video signal.

27. The apparatus of claim 26 wherein the selector is operable to apply a first filter to input video signals having perturbations in the input video signal less than a first predetermined level and apply a second different filter to input video signals having perturbations more than the first predetermined level.

28. The apparatus of claim 23 further comprising a mixer operable to combine the encoder motion prediction signal and filtered preprocessor residual signal.

29. The apparatus of claim 28 wherein the mixer adds the encoder motion prediction signal and the filtered preprocessor signal.

30. The apparatus of claim 21 wherein the preprocessor is operable to directly modify the input video signal including modifying the input video signal based on a motion prediction of the input video signal.

31. The apparatus of claim 30 wherein the preprocessor further includes a motion compensation module operable to directly modifying the input video signal to provide a motion compensated prediction of an encoder prediction signal and provide the motion compensated prediction as an input to the encoder system.

32. The apparatus of claim 21 wherein the preprocessor is operable to
preprocess the video input signal to produce a preprocessed video input signal; and
combine the pre-processed video input signal with the encoder motion prediction signal.

33. The apparatus of claim 20 wherein the preprocessor is operable to preprocess the video input signal to produce a preprocessed video input signal; and wherein the apparatus further includes a second preprocessor operable to combine the pre-processed video input signal with the encoder motion prediction signal.

34. The apparatus of claim 33 wherein the second preprocessor further includes a mixer operable to combine the pre-processed video input signal with the encoder motion prediction signal.

35. The apparatus of claim 34 wherein the mixer is operable to provide a weighted combination of the preprocessed video input signal and the encoder motion prediction signal.

36. The apparatus of claim 20 wherein the preprocessor is operable to combine a motion prediction estimate produced by the preprocessor of the input video signal and the encoder motion prediction signal.

37. The apparatus of claim 36 wherein the preprocessor includes a motion prediction module that is operable to produce a motion compensated estimate of the video input signal and a sigma module that is operable to combine the motion compensated estimate produced by the motion compensation module and the encoder motion prediction signal.

38. The apparatus of claim 37 wherein the sigma module is operable to weight a combination of the motion compensated estimate and the encoder motion prediction signal.

39. The apparatus of claim 38 wherein the sigma module is configurable to disregard the encoder motion prediction signal in the combination.

40. The apparatus of claim 38 wherein the sigma module is configurable to disregard the motion compensated estimate in the combination.

41. The apparatus of claim 38 wherein the sigma module is configurable to generate a weighted combination of both the encoder motion prediction signal and the motion compensated estimate.

42. A method for preprocessing a video signal prior to encoding by a motion compensated prediction encoding system, the method comprising:
modify an input video signal to maximize the input video signal's conformance with a prediction model used by the motion compensated prediction encoding system.

43. A method for preprocessing a video signal prior to encoding in an encoding system, the method comprising:
blending a current input video frame with an encoder system's motion-predicted reconstruction producing a blended frame with quantization noise; and
providing the blended frame to the encoder system for encoding.
